(19) United States
(12) Patent Application Publication
(10) Pub. No.: US 2004/0022682 A1
(43) Pub. Date: Feb. 5, 2004

(54) Specimen preprocessing and conveyig system

(76) Inventor: Teruaki Itoh, Kumamoto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/629,828

(22) Filed: Jul. 30, 2003

(30) Foreign Application Priority Data
Jul. 31, 2002 (JP) 2002-223924

(51) Int. Cl. G01N 35/02

(52) U.S. Cl. 422/64; 422/65

(57) ABSTRACT

A specimen preprocessing and conveying system includes an analytic apparatus which receives a specimen container from a first conveying line, analyzes a specimen in the specimen container, and moves the specimen container onto the first conveying line, a stockyard which stocks the specimen container whose specimen has been analyzed, removes the specimen container when necessary, and selectively moves the specimen container onto the first and the second conveying line, a monitor control unit which monitors an analytical result and issues a reanalysis instruction to a specimen container when the specimen container contains a specimen that needs to be reanalyzed, and a reanalysis control unit which removes the specimen container to which the reanalysis instruction is issued, from the stockyard, conveys the specimen container to the second conveying line to be sent back to the analytic apparatus.

### CROSS-REFERENCE TO RELATED APPLICATIONS

This application is based upon and claims the benefit of priority from the prior Japanese Patent Application No. 2002-223924, filed Jul. 31, 2002, the entire contents of which are incorporated herein by reference.

### BACKGROUND OF THE INVENTION

1. Field of the Invention

The present invention relates to a specimen preprocessing and conveying system having a function of automatically reanalyzing a specimen when the specimen is found as one that needs to be reanalyzed during its conveyance.

2. Description of the Related Art

A prior art specimen preprocessing and conveying system is configured as follows. A specimen such as blood is carried onto a conveying lane and centrifuged. Then, the specimen is conveyed to an analytic apparatus and subjected to a given analysis. After that, the specimen is carried out by the conveying lane.

More specifically, when a specimen to be reanalyzed is found from those under conveyance, he or she removes a container containing the specimen from the conveying lane and sends it back to the analytic apparatus. The specimen is reanalyzed by the analytic apparatus and then returned to the original conveying lane.

As described above, in the prior art specimen preprocessing and conveying system, an operator sends a container containing a specimen to be reanalyzed back to a predetermined analytic apparatus. It is thus impossible to conduct the reanalysis quickly and accurately.

### BRIEF SUMMARY OF THE INVENTION

An object of the present invention is to provide a specimen preprocessing and conveying system having a function capable of reanalyzing a specimen quickly and accurately.

In order to attain the above object, the specimen preprocessing and analyzing system according to the present invention has the following characteristic configuration. The other characteristic configurations will be clarified in the Detailed Description of the Invention.

A specimen preprocessing and conveying system comprising:

a conveying line including a first conveying line which allows a specimen container to be conveyed in a forward direction along a processing route and a second conveying line which allows the specimen container to be conveyed in a backward direction against the processing route, the first conveying line and the second conveying line being arranged in parallel with each other;

an analytic apparatus which receives the specimen container from the first conveying line of the conveying line, analyzes a specimen in the specimen container, and moves the specimen container onto the first conveying line;

a stockyard which receives and stocks the specimen container whose specimen has been analyzed by the analytic apparatus, removes the specimen container when necessary, and selectively moves the specimen container onto the first conveying line and the second conveying line;

a monitor control unit which monitors an analytical result of the analytic apparatus and issues a reanalysis instruction to the specimen container stocked in the stockyard when the specimen container contains a specimen that needs to be reanalyzed; and

a reanalysis control unit which removes the specimen container to which the monitor control unit issues the reanalysis instruction, from the stockyard, conveys the specimen container on the second conveying line in the backward direction opposite to the forward direction of the first conveying line to the analytic apparatus, and reanalyzes the specimen in the specimen container.

### BRIEF DESCRIPTION OF THE SEVERAL VIEWS OF THE DRAWING

FIG. 1 is a perspective view of the outward appearance of a specimen preprocessing and conveying system according to an embodiment of the present invention.

FIG. 2 is an enlarged perspective view of the configuration of the main part of a conveying line of the specimen preprocessing and conveying system according to the embodiment of the present invention.

FIG. 3 is a block diagram showing a function of the specimen preprocessing and conveying system according to the embodiment of the present invention.

### DETAILED DESCRIPTION OF THE INVENTION

### Embodiment

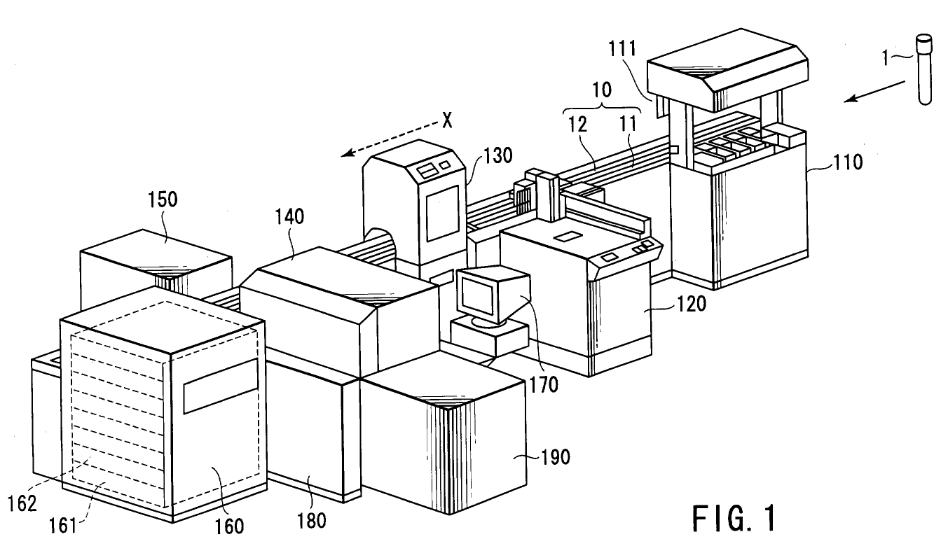

As shown in FIG. 1, a specimen preprocessing and conveying system according to an embodiment of the present invention comprises a conveying line 10 for conveying a specimen. The conveying line 10 includes a first conveying line 11 and a second conveying line 12 which are arranged in parallel with each other. The first conveying line 11 allows specimen containers 1 each containing a specimen to be conveyed in the forward direction along a processing route indicated by a broken arrow X. The second conveying line 12 allows the specimen containers to be conveyed in the direction against the processing route.

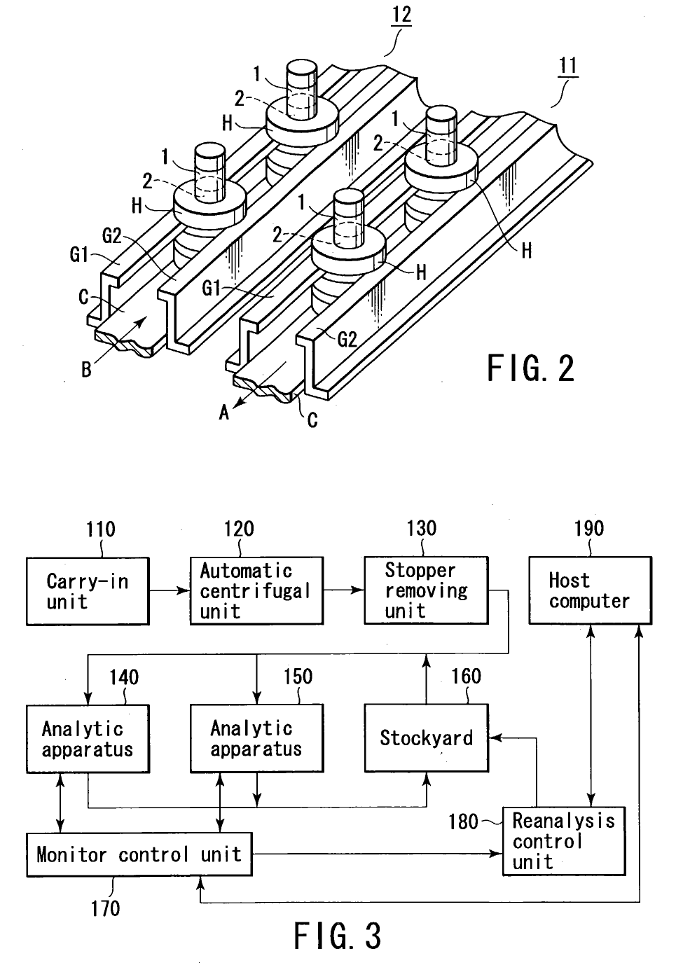

As shown in FIG. 2, the first and second conveying lines 11 and 12 each have a pair of guide rails G1 and G2, a conveyor belt C that is moved in its longitudinal direction along the bottoms of the guide rails G1 and G2, and specimen container holders H that are each moved while its bottom is supported by the conveyor belt C and they are each caught between the edge portions of the guide rails G1 and G2. The specimen container holders H are capable of vertically holding the specimen containers 1 (e.g., test tubes) each containing a specimen 2 such as blood. The specimen container holders H on the first conveying line 11 are conveyed in the forward direction indicated by arrow A. The specimen container holders H on the second conveying line 12 are conveyed in the backward direction indicated by arrow B.

Referring back to FIG. 1, a carry-in unit 110 moves the specimen containers 1, which are stored in a storage rack (not shown) placed near the conveying line 10, to the specimen container holders H (see FIG. 2) on the first conveying line 11 using a robot arm 111.

A centrifugal unit 120 receives the specimen containers 1 from the specimen container holders H on the conveying line 11 in a centrifugal rotor section and centrifuges a specimen in each of the specimen containers. The specimen containers 1 whose specimens have been centrifuged are moved to the specimen container holders H on the first conveying line 11 by a robot arm (not shown).

After the centrifugation, a stopper removing unit 130 automatically removes and disposes of the stoppers of the specimen containers 1 held in the specimen container holders H on the first conveying line 11.

Analytic apparatuses (two analytic apparatuses in the present embodiment) 140 and 150 . . . of different types receive a designated one of the specimen containers whose stoppers are removed by the stopper removing unit 130 and conduct a specific analysis for the specimen 2 in the designated specimen container 1. After the analysis, the designated specimen container 1 is moved to the specimen container holder H on the first carrying line 11 by the robot arm (not shown).

A stockyard 160 organizes the specimen containers 1, whose specimens have been analyzed by the analytic apparatuses 140 and 150, and stocks them on stock floors 161, 162 . . . by the robot arm (not shown). If necessary, the specimen containers 1 can selectively be moved to the specimen holders H on the first carrying line 11 and the second carrying line 12.

As shown in FIG. 3, a monitor control unit 170 monitors the analytical results of the analytic apparatuses 140 and 150. When the unit 170 finds a specimen to be reanalyzed, it issues a reanalysis instruction to the specimen container 1 containing the specimen.

A reanalysis control unit 180 removes the specimen container 1 from the stockyard 160 in response to the reanalysis instruction issued from the monitor control unit 170. Then, the unit 180 moves the specimen container 1 onto the second conveying line 12 and conveys it in the backward direction as indicated by arrow B (see FIGS. 1 and 2). Thus, the specimen container 1 is sent back to the analytic apparatus 140 or 150 and reanalyzed therein.

The monitor control unit 170 and reanalysis control unit 180 are operated in association with each other by exchanging information with a host computer 190.

### Features of Embodiment

[1] A specimen preprocessing and conveying system according to an embodiment of the present invention, comprises: .

a conveying line 10 including a first conveying line 11 which allows a specimen container 1 to be conveyed in a forward direction A along a processing route X and a second conveying line 12 which allows the specimen container 1 to be conveyed in a backward direction B against the processing route X, the first conveying line 11 and the second conveying line 12 being arranged in parallel with each other;

an analytic apparatus 140 (150) which receives the specimen container 1 from the first conveying line 11 of the conveying line 10, analyzes a specimen 2 in the specimen container 1, and moves the specimen container 1 onto the first conveying line 11;

a stockyard 160 which receives and stocks the specimen container 1 whose specimen 2 has been analyzed by the analytic apparatus 140 (150), removes the specimen container 1 when necessary, and selectively moves the specimen container 1 onto the first conveying line 11 and the second conveying line 12;

a monitor control unit 170 which monitors an analytical result of the analytic apparatus 140 (150) and issues a reanalysis instruction to the specimen container I stocked in the stockyard 160 when the specimen container 1 contains a specimen that needs to be reanalyzed; and

a reanalysis control unit 180 which removes the specimen container 1 to which the monitor control unit 170 issues the reanalysis instruction, from the stockyard 160, conveys the specimen container 1 on the second conveying line 12 in the backward direction opposite to the forward direction of the first conveying line 11 to the analytic apparatus 140 (150), and reanalyzes the specimen in the specimen container 1.

In the specimen preprocessing and conveying system described above, when a monitor control unit 170 finds a specimen to be reanalyzed in a specimen container 1, the specimen container 1 is automatically sent to an analytic apparatus 140 (150) and the specimen is reanalyzed. Therefore, an operator need not perform the reanalysis operation but the system can do it quickly and accurately.

[2] A specimen preprocessing and conveying system according to an embodiment of the present invention, comprises:

a conveying line 10 including a first conveying line 11 which allows a plurality of specimen containers 1 to be conveyed in a forward direction A along a processing route X and a second conveying line 12 which allows the specimen containers 1 to be conveyed in a backward direction B against the processing route X, the first conveying line 11 and the second conveying line 12 being arranged in parallel with each other;

a carry-in unit 110 which moves a plurality of specimen containers 1, which are stored in a storage rack (not shown) placed near the conveying line 10, to respective specimen container holders H on the first conveying line 11 using a robot arm 111;

a centrifugal unit 120 which receives the specimen containers 1 from the specimen container holders H on the first carrying line 11, centrifuges specimens in the specimen containers 1, and moves the specimen containers 1 whose specimens have been centrifuged to the specimen container holders H on the first conveying line 11;

a stopper removing unit 130 which removes and disposes of a stopper of each of the specimen containers 1 moved to the specimen container holders H on the first conveying line 11 after the specimens in the specimen containers 1 are centrifuged by the centrifugal unit 120;

analytic apparatuses 140, 150 . . . of different types which receive given specimen containers 1 of the specimen containers 1 whose stoppers are removed by the stopper removing unit 130, analyze specimens 2 in the given specimen containers 1, and moves the given specimen containers 1 to respective specimen container holders H on the first conveying line 11;

a stockyard 160 which receives the specimen containers 1 whose specimens have been analyzed by the analytic apparatuses 140, 150 . . . by a robot arm (not shown), stocks the specimen containers 1 on stock. floors 161, 162 . . . and selectively moves the specimen containers 1 to the specimen container holders H on the first conveying line 11 and the specimen container holders H on the second conveying line 12 when necessary;

a monitor control unit 170 which monitors analytical results of the analytic apparatuses 140, 150 . . . and issues a reanalysis instruction to the specimen containers 1 stocked in the stockyard 160 when the specimen containers 1 contain specimens that need to be reanalyzed; and

a reanalysis control unit 180 which removes the specimen containers 1 to which the monitor control unit 170 issues the reanalysis instruction, from the stockyard 160, conveys the specimen containers 1 to the specimen container holders H on the second conveying line 12 in the backward direction opposite to the forward direction of the first conveying line 11 to be sent back to the analytic apparatuses 140, 150 . . . and reanalyzes the specimens in the specimen containers 1.

[3] The specimen preprocessing and conveying system according to one of above items [1] and [2], wherein the monitor control unit 170 and the reanalysis control unit 180 are operated in association with each other by exchanging information with a host computer 190.

### Modifications

The specimen preprocessing and conveying system according to the embodiment of the present invention can be modified as follows:

The host computer 190 can be replaced with a host computer for an integrated management system at a location other than the specimen preprocessing and conveying system.

A display device can be provided to display the specimen number of a specimen to be reanalyzed, the name of an analytic apparatus for reanalysis, and various items of information on the progress of the reanalysis together.

What is claimed is:

1. A specimen preprocessing and conveying system comprising:
a conveying line including a first conveying line which allows a specimen container to be conveyed in a forward direction along a processing route and a second conveying line which allows the specimen container to be conveyed in a backward direction against the processing route, the first conveying line and the second conveying line being arranged in parallel with each other;
an analytic apparatus which receives the specimen container from the first conveying line of the conveying line, analyzes a specimen in the specimen container, and moves the specimen container onto the first conveying line;
a stockyard which receives and stocks the specimen container whose specimen has been analyzed by the analytic apparatus, removes the specimen container when necessary, and selectively moves the specimen container onto the first conveying line and the second conveying line;
a monitor control unit which monitors an analytical result of the analytic apparatus and issues a reanalysis instruction to the specimen container stocked in the stockyard when the specimen container contains a specimen that needs to be reanalyzed; and
a reanalysis control unit which removes the specimen container to which the monitor control unit issues the reanalysis instruction, from the stockyard, conveys the specimen container on the second conveying line in the backward direction opposite to the forward direction of the first conveying line to the analytic apparatus, and reanalyzes the specimen in the specimen container.

2. A specimen preprocessing and conveying system comprising:
a conveying line including a first conveying line which allows a plurality of specimen containers to be conveyed in a forward direction along a processing route and a second conveying line which allows the specimen containers to be conveyed in a backward direction against the processing route, the first conveying line and the second conveying line being arranged in parallel with each other;
a carry-in unit which moves a plurality of specimen containers, which are stored in a storage rack placed near the conveying line, to respective specimen container holders on the first conveying line using a robot arm;
a centrifugal unit which receives the specimen containers from the specimen container holders on the first carrying line, centrifuges specimens in the specimen containers, and moves the specimen containers whose specimens have been centrifuged to the specimen container holders on the first conveying line;
a stopper removing unit which removes and disposes of a stopper of each of the specimen containers moved to the specimen container holders on the first conveying line after the specimens in the specimen containers are centrifuged by the centrifugal unit;
analytic apparatuses of different types which receive given specimen containers of the specimen containers whose stoppers are removed by the stopper removing unit, analyze specimens in the given specimen containers, and moves the given specimen containers to respective specimen container holders on the first conveying line;
a stockyard which receives the specimen containers whose specimens have been analyzed by the analytic apparatuses by a robot arm, stocks the specimen containers on stock floors, and selectively moves the specimen containers to the specimen container holders on the first conveying line and the specimen container holders on the second conveying line when necessary;
a monitor control unit which monitors analytical results of the analytic apparatuses and issues a reanalysis instruction to the specimen containers stocked in the stockyard when the specimen containers contain specimens that need to be reanalyzed; and
a reanalysis control unit which removes the specimen containers to which the monitor control unit issues the reanalysis instruction, from the stockyard, conveys the specimen containers to the specimen container holders on the second conveying line in the backward direction opposite to the forward direction of the first conveying line to be sent back to the analytic apparatuses, and reanalyzes the specimens in the specimen containers.

3. The specimen preprocessing and conveying system according to claim 1, wherein the monitor control unit and the reanalysis control unit are operated in association with each other by exchanging information with a host computer.

4. The specimen preprocessing and conveying system according to claim 2, wherein the monitor control unit and the reanalysis control unit are operated in association with each other by exchanging information with a host computer.
